(19) United States
(12) Patent Application Publication
(10) Pub. No.: US 2017/0059344 A1
(43) Pub. Date: Mar. 2, 2017

(54) SYSTEM, METHOD, AND DEVICE FOR ROUTING THROUGH CRIME AREAS

(71) Applicant: Leigh Mitchell Rothschild, MIAMI, FL (US)

(72) Inventor: Leigh Mitchell Rothschild, MIAMI, FL (US)

(73) Assignee: Ariel Inventions, LLC, MIAMI, FL (US)

(21) Appl. No.: 15/076,690

(22) Filed: Mar. 22, 2016

Related U.S. Application Data
(60) Provisional application No. 62/211,875, filed on Aug. 31, 2015.

(51) Int. Cl. G01C 21/34; G01C 21/36

(52) U.S. Cl. CPC G01C 21/3461; G01C 21/3667

(57) ABSTRACT

A navigation system, device, and method for providing a route to a user for travelling based on one or more crime statistics. The user is provided crime related information based on up to date statistics of any selected route or predefined area, and additionally the user is provided alerts upon entering a high crime density area. Moreover, the user is also facilitated with a route that the user may have previously utilized and the corresponding current crime statistics.

### CROSS-REFERENCE TO RELATED PATENT APPLICATION

The present application is related to and claims priority of U.S. provisional patent application titled “System and Method and Device for Vehicle Routing Utilizing Users Predefined Criteria to Avoid Dangerous Areas”, Ser. No. 62/211,875, filed on Aug. 31, 2015, the description of the same is incorporated herein in its entirety.

### FIELD OF THE DISCLOSURE

The presently disclosed embodiments are generally related to navigation systems, and more particularly to a navigation system that facilitates routing by avoiding areas with high crime density.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Each year millions of global positioning devices and electronic navigation devices are purchased worldwide. Many of these devices are used for routing individuals or groups from one location to another. The currently available Global Positioning Systems (GPS) allow a user to know the traffic and any accidents along the selected or instant route. Such Global Positioning Systems also display time to destination, speed of travel, traffic cameras along the route, weather, and other route conditions. One variable that is currently missing in GPS routing devices is the ability to tell a user about the safety of a selected or instant route. For example, if a user selects a certain route or is following a route that takes the user into a high density crime area, then the currently available GPS devices do not have the capability to alert the user about the safety concerns of that particular area. Further, the user is currently not warned of this safety factor when selecting a route. It is also common when using GPS routing systems for a user to vary from the selected route either by mistake or intentionally and end up in a high crime density area. In such a case, the user needs to be alerted about the same.

The need for a GPS device that avoids or alerts regarding high crime areas is intensified in a war struck zone especially for the military personnel and military vehicles. Current GPS routing devices are unable to provide information to the users on all known crime factors that may affect the user's safety while travelling along a route.

Hence, there is a need for a device, system, and method that provides a user the safety of routing their vehicle through a safe area of roads or waterways or airstreams based on currently available up-to-date statistics. Further, there exists a need for a system, method and device that allows a user to utilize previously selected routing patterns and to show if a selected route is safe or not.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a system for vehicle routing through low crime areas is described. The system may comprise one or more electronic devices and one or more remote servers. The one or more remote servers are communicatively coupled with the one or more electronic devices by means of a network. The one or more electronic devices may send geographical information corresponding to the one or more electronic devices to the one or more remote servers. The one or more remote servers may retrieve crime related information corresponding to the geographical information of the one or more electronic devices. The retrieved crime related information may then be sent from the one or more remote servers to the corresponding one or more electronic devices. Upon receiving the crime related information, an alert may be generated by the one or more electronic devices based on the corresponding crime related information.

In an example embodiment, a device for vehicle routing through low crime areas is described. The electronic device may comprise a communication module, a GPS location module, a processor, and a user interface. The communication module may be enabled to retrieve crime related information. The GPS location module may be enabled to retrieve geographical information from one or more global positioning satellites. The processor may be enabled to process crime related information retrieved from one or more remote servers and the one or more global positioning satellites. The processor may trigger the user interface to generate an alert based on processing the received geographical information and the crime related information.

In an example embodiment, a method for vehicle routing through low crime areas is described. The method comprises the processor implemented steps of receiving geographical information corresponding to the one or more electronic devices, by one or more remote servers; retrieving crime related information related to the geographical information of the one or more electronic devices, by one or more remote servers; sending the retrieved crime related information to the corresponding one or more electronic devices, by one or more remote servers; and generating an alert by each of the one or more electronic devices based on the corresponding crime related information.

### BRIEF DESCRIPTION OF THE DRAWINGS

The accompanying drawings illustrate various embodiments of systems, devices, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a device for enabling routing through low crime areas, according to an example embodiment.

FIG. 2 illustrates a system for enabling routing through low crime areas, according to an example embodiment.

FIG. 3 illustrates a method for enabling routing through low crime areas, according to an example embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Unless specifically stated otherwise, as apparent from the following discussion, it is appreciated that throughout this specification discussions utilizing terms such as “processing.” “computing,” “calculating,” “selecting,” “forming,” “enabling,” “extracting,” “inhibiting,” “identifying,” “comparing,” “representing,” “modifying,” “receiving,” “transmitting,” “storing,” “authenticating,” “authorizing,” “determining.” “slicing,” “hashing,” “generating” or the like refer to the actions or processes that may be performed by a computing platform, such as a computer or a similar electronic computing device, that is operable to manipulate or transform data represented as physical, electronic or magnetic quantities or other physical quantities within the computing platform's processors, memories, registers, or other information storage, transmission, reception or display devices. Accordingly, a computing platform refers to a system or a device that includes the ability to process or store data in the form of signals. Thus, a computing platform, in this context, may comprise hardware, software, firmware or any combination thereof. Further, unless specifically stated otherwise, a process as described herein, with reference to flowcharts or otherwise, may also be executed or controlled, in whole or in part, by a computing platform.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is an object of the current disclosure to provide a system, method and device that enables a user to know if they are in a safe area, and further to avoid unsafe high density crime areas when selecting routing.

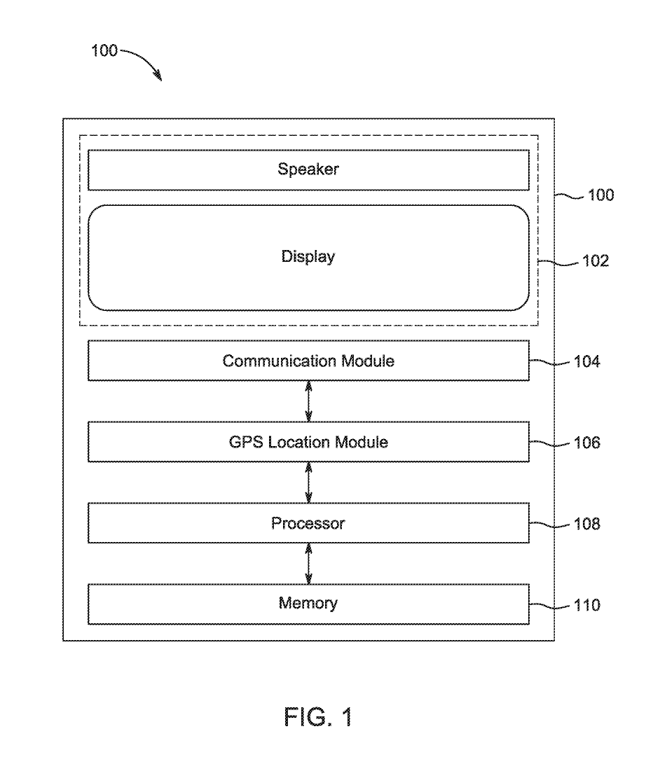

FIG. 1 illustrates a device for enabling routing through low crime areas, according to an example embodiment. The electronic device 100 may be a Global Position Satellite (GPS) system, or a Personal Digital Assistant (PDA) device, or a personal computer, or a laptop, or a tablet, or a mobile phone and the like. The electronic device 100 may be installed in a vehicle such as personal car, or a motorcycle, or a bicycle, or a driverless car, or a military vehicle, or a commercial vehicle and the like. The electronic device 100 may include a user interface 102, a communication module 104, a GPS location module 106, a processor 108, and a memory 110. In an aspect, the user interface 102 may comprise a speaker and a display screen. The user interface 102 is enabled to output certain data and may also enable a user to input certain data and instructions. The display screen may be configured to display information received by the communication module 104. Display screen may include any of a variety of user interface components. The display screen may include a liquid crystal display (LCD) display, a cathode ray tube (CRT) display, a plasma display, or another type of display. As another example, the display screen may be integrated with an input unit and include a data entry component, such as a keyboard in a QWERTY keyboard arrangement, a touch screen such as a resistive or capacitive touch screen, or another type of data entry component. In an aspect, the user interface 102 may include an input unit for entering data and instructions. The input unit may facilitate entering one or more commands that needs to be sent to another electronic device, or to the processor 108, or to a remote server. The input unit may act as a data entry component, such as a keyboard in a QWERTY keyboard arrangement, a touch screen such as a resistive or capacitive touch screen, a voice recognition interface, or another type of data entry component.

The various components of electronic device 100 may be communicatively coupled with each other by means of a bus or a network of cables in a desired configuration. In one aspect, the various components may also be embedded on a single circuit board. The GPS location module 106 may enable determining the GPS coordinates of the electronic device 100 by means of communicating with one or more Global Positioning System navigation satellites.

The communication module 104 may be communicatively coupled with one or remote servers. The communication module 104 may send the geographical information retrieved by the GPS location module 106 to the one or more remote servers. The communication module 104 may also enable receiving certain information such as crime related information related to the geographical information from the one or more remote servers. The communication module 104 may also enable receiving certain data and instructions from one or more other electronic devices. The received data and instructions may then be stored in the memory 110. Alternatively, the communication module 104 may enable sending certain data and instructions that are stored in the memory 110 or inputted by means of the user interface 102 to one or more other electronic devices, or to one or more remote servers.

The processor 108 may execute computer program instructions stored in the memory 110. The processor 108 may also be configured to decode and execute any instructions received from one or more other electronic devices or one or more remote servers. The processor may also execute a client application for desired functioning of the electronic device 100. Processor 108 may include one or more general purpose processors (e.g., INTEL microprocessors) and/or one or more special purpose processors (e.g., digital signal processors). Processor 108 is configured to execute one or more computer-readable program instructions, such as program instructions to carry out any of the functions described in this description.

The memory 110 may include a computer readable medium. A computer readable medium may include volatile and/or non-volatile storage components, such as optical, magnetic, organic or other memory or disc storage, which may be integrated in whole or in part with a processor, such as processor 108. Alternatively, the entire computer readable medium may be remote from processor 108 and coupled to processor 108 by connection mechanism and/or network cable. In addition to memory 110, there may be additional memories that may be coupled with the processor 108.

The electronic device 100 enables routing through low crime areas. The GPS location module 106 may enable retrieving geographical information from one or more global positioning satellites. In an aspect, the geographical information comprises the current location coordinates of the electronic device 100. In another aspect, the geographical information comprises the geographical coordinates of a starting location and a destination location. The retrieved geographical information may then be used by the communication module 104 for retrieving crime related information corresponding to the geographical information.

In an aspect, the communication module 104 may send the geographical information to one or more remote servers. The one or more remote servers upon receiving the geographical information may in turn retrieve crime related information corresponding to the geographical information. The one or more remote servers then send the crime related information to the communication module 104.

In another aspect, the crime related information such as the crime statistics of a given geographical location may be pre-stored in an internal non-removable memory of the electronic device 100. In yet another aspect, the crime related information such as the crime statistics of a given geographical location may be received from a removable memory storage associated with the electronic device 100. In such cases, the communication module 104 may retrieve the crime related information from the memory itself.

The retrieved crime related information is then sent to the processor 108 by the communication module 104. The processor 108 then processes the geographical information and the corresponding crime related information. The processor 108 may trigger the user interface 102 to generate an alert based on processing of the received geographical information and the corresponding crime related information.

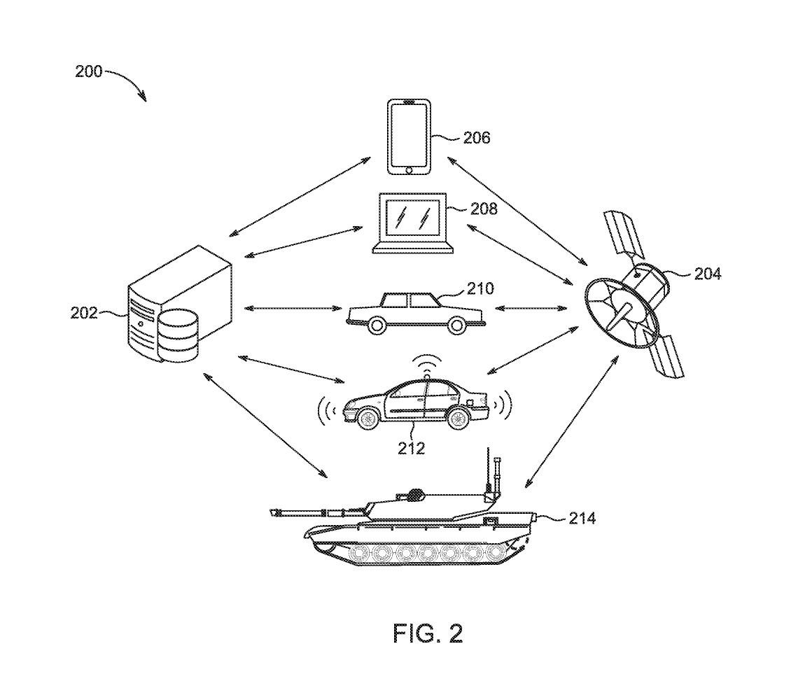

FIG. 2 illustrates a system 200 for enabling routing through low crime areas, according to an example embodiment. The system 200 comprises of one or more electronic devices 100. The electronic device 100 may be a device capable of communication and processing such as a smartphone 206, or a laptop 208, or a tablet. The electronic device 100 may also be certain communication and processing module that may be embedded in a vehicle such as car 210, or a driverless car 212, or a military vehicle 214. The electronic devices 100 may be capable of being communicatively coupled with each other. The system 200 also comprises of one or more global positioning system satellites 204, and one or more remote servers 202. The one or more remote servers 202 are communicatively coupled with the one or more electronic devices. The one or more electronic devices 100 are also capable of retrieving geographical information from the one or more global positioning system satellites 204. The one or more electronic devices 100 may send the geographical information to the one or more remote servers 202. The one or more remote servers 202 upon receiving the geographical information may retrieve crime related information related to the geographical information of the one or more electronic devices 100. The retrieved crime related information may then be sent to the corresponding one or more electronic devices 100. In an aspect, the crime related information may comprise crime statistics regarding one or more geographic locations, and/or density of crime associated with the one or more geographic locations, and/or a coverage area of the crime density associated with the one or more geographic locations, and/or the crime statistics mapped on geographical information corresponding to the one or more electronic devices 100. The one or more electronic devices 100 may then generate an alarm based on the corresponding crime related information. The alert may be a pop-up message, a text alert, an audio alert, a visual alert, or a haptic feedback. In an aspect, the geographical information is sent from each electronic device 100 and the corresponding crime related information is sent from each remote server, at a pre-selected programmed time intervals.

In an example embodiment, the system 200 may enable the electronic device 100 to retrieve a route between a source location and a destination location to the user. The source location coordinates and the destination location coordinates may be retrieved by the communication module 104 upon receiving the corresponding instruction from the user interface 102. The communication module 104 may retrieve the source location coordinates and the destination location coordinates by communicating with the one or more global positioning system satellites 204. The retrieved source location coordinates and the destination location coordinates may then be sent to the one or more remote servers 202. The one or more remote servers 202 may then retrieve crime related information corresponding one or more possible routes between the source location and the destination location. In an aspect, the route having least crime density may be sent to the electronic device by the one or more remote servers 202. In another aspect, the one or more remote servers 202 may send one or more possible routes between the source location and the destination location along with a mapping of corresponding crime density with each of the one or more routes.

In an aspect, the system 100 facilitates mapping crime statistics and crime alerts on a digital map that is utilized by the electronic device. The electronic device presents crime statistics or other crime alerts displayed on a graphical map that the device presents to the user as part of the users routing and directions from point to point. The crime information may also come to the user on the device in the form of an alert. For example, if there is a special Alert, this information can be displayed in text or via audio with the electronic device. In addition the notation of a special alert may be graphically mapped on the users route, so that while the user is travelling that specific route a text balloon, or map highlight, or audio alert, or some other type of indication lets the user know that for that specific route a special alert exists.

In another example embodiment, the system 200) may enable the one or more electronic devices 100 to retrieve crime related information regarding the current location of the user. In such a case, the geographical information comprises the current geographical location of the one or more electronic devices 100. Accordingly, the corresponding crime related information is sent by the one or more remote servers 202.

In an aspect, the memory 110 may store a route previously taken by the user. The electronic device 100 may automatically retrieve the current crime statistics of the stored route and may display the crime density along the route previously taken by the user on the user interface 102. For example, a driverless car may take decision regarding a route based on the familiarity of the user and current crime density of the areas along the route.

In another embodiment, the vehicle in which the electronic device 100 is installed or located may take a route according to the user's choice. In such a case, the electronic device 100 may periodically retrieve and send the geographical information to the one or more remote servers 202. Likewise, the remote servers 202 may send the corresponding crime related information to the electronic device 100. The processor 108 of the electronic device 100 may continually process the received crime related information, and if the current location of the vehicle is detected to be in a high crime density area then an appropriate alert may be generated by means of the user interface 102.

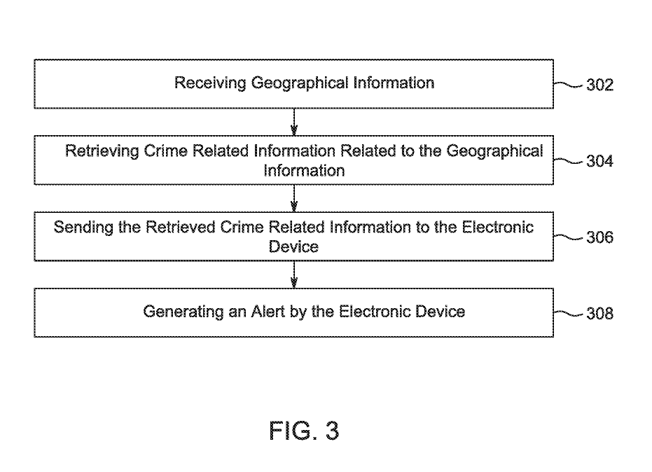

FIG. 3 illustrates a method for enabling routing through low crime areas, according to an example embodiment. At step 302, the geographical information corresponding to the one or more electronic devices 100 is retrieved and sent to the one or more remote servers 202. At step 304, crime related information related to the geographical information of the one or more electronic devices 100 is retrieved, by one or more remote servers 202. At step 306, the retrieved crime related information is sent to the corresponding one or more electronic devices 100, by one or more remote servers 202. Finally at step 308, an alert may be generated by each of the one or more electronic devices 100 based on the corresponding crime related information.

In an aspect, routing information may be generated for each of the one or more electronic devices 100 based on the crime related information related to the one or more geographic location. The generated routing information may then be displayed on the user interface 102 of the electronic device 100. In an aspect, one or more routes between two geographic locations may be tagged with a user generated data that is indicative of the safety associated the one or more routes. The tagged one or more routes may be stored in a corresponding internal non-removable memory 110 of each of the one or more electronic devices 100. Such stored tagged one or more routes may be communicatively shared between one or more other electronic devices 100. The routes may be retrieved by the user in the future upon the users request. For example, military vehicles of an army may share the safe routes between themselves.

In an aspect, pre-stored crime statistics may be transmitted to one or more other electronic devices 100 that are communicatively coupled with each other. For example, the crime statistics may be shared between a fleet of commercial vehicles.

The flow chart of FIG. 3 shows the method steps executed according to one or more embodiments of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

In an aspect, the method comprises of collecting crime statistical information and crime alerts and mapping such information on a digital map that is utilized by the electronic device.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system for vehicle routing through crime areas, comprising:
one or more electronic devices; and
one or more remote servers, the one or more remote servers being communicatively coupled with the one or more electronic devices,
wherein the one or more electronic devices send geographical information corresponding to the one or more electronic devices to the one or more remote servers, the one or more remote servers retrieve crime related information related to the geographical information of the one or more electronic devices and send the retrieved crime related information to the corresponding one or more electronic devices.

2. The system of claim 1, wherein the geographical information comprises a source location and a destination location.

3. The system of claim 1, wherein the geographical information comprises the current geographical location of the one or more electronic devices.

4. The system of claim 1, wherein the crime related information comprises crime statistics regarding one or more geographic locations, and/or density of crime associated with the one or more geographic locations, and/or a coverage area of the crime density associated with the one or more geographic locations, and/or the crime statistics mapped on geographical information corresponding to the one or more electronic devices.

5. The system of claim 4, wherein the crime related information is mapped on a graphic digital map and displayed by the one or more electronic devices.

6. The system of claim 1, wherein the one or more electronic devices are installed in a vehicle selected from the group consisting of a driverless car, a military vehicle, and a commercial vehicle.

7. The system of claim 1, wherein the geographical information is sent from each electronic device and the corresponding the crime related information is sent from each remote server, at preselected programmed time intervals.

8. The system of claim 1, wherein the one or more electronic devices generate an alert based on the corresponding crime related information.

9. The system of claim 8, wherein the alert is one or more of: a pop-up, a text alert, an audio alert, a visual alert, and a haptic feedback.

10. An electronic device for vehicle routing through crime areas, said electronic device comprising:
a communication module for retrieving crime related information;
a GPS location module for retrieving geographical information from one or more global positioning system satellites;
a processor for processing crime related information retrieved from one or more remote servers and the geographical information retrieved from the one or more global positioning system satellites;
and a user interface for enabling input and output.

11. The electronic device of claim 10, wherein the processor triggers the user interface to generate an alert based on processing of the received geographical information and the crime related information.

12. The electronic device of claim 10, wherein the electronic device is selected from the group consisting of a Global Position Satellite (GPS) system, a Personal Digital Assistant (PDA) device, a personal computer, a laptop, a tablet, and a mobile phone.

13. The electronic device of claim 10, wherein the user interface comprises a speaker and a display screen.

14. The electronic device of claim 10, wherein the communication module is communicatively coupled with the one or remote servers, and sends the geographical information retrieved by the GPS location module to the one or more remote servers, and receives crime related information related to the geographical information from the one or more remote servers.

15. The electronic device of claim 10, wherein the crime statistics are pre-stored in an internal non-removable memory of the electronic device.

16. The electronic device of claim 10, wherein the crime statistics are received from a removable memory storage associated with the electronic device.

17. A method for vehicle routing through crime areas, said method comprising:
receiving geographical information corresponding to the one or more electronic devices, by one or more remote servers:
retrieving crime related information related to the geographical information of the one or more electronic devices, by one or more remote servers;
sending the retrieved crime related information to the corresponding one or more electronic devices, by one or more remote servers.

18. The method of claim 17, further comprising:
generating an alert by each of the one or more electronic devices based processing of the geographical information and the corresponding crime related information.

19. The method of claim 17, further comprising:
generating a routing information for each of the one or more electronic devices based on the crime related information related to the one or more geographic location; and
displaying the generated routing information on a display device associated with the user.

20. The method of claim 17, further comprising transmitting pre-stored crime statistics to the one or more other electronic devices.

21. The method of claim 17, further comprising tagging one or more routes between the one or more geographic locations with a user generated data that is indicative of at least safety associated the one or more routes.

22. The method of claim 21, further comprising storing the tagged one or more routes in a corresponding internal non-removable memory of each of the one or more electronic devices.

23. The method of claim 22, further comprising transmitting the stored tagged one or more routes between the one or more other electronic devices.

24. A global positioning device for vehicle routing through crime areas, the global positioning device being communicatively coupled with a remote server, wherein the global positioning device sends a request to the remote server for obtaining crime statistics information for a particular geographic location or a range of locations, the global positioning device receives the crime statistics information and then outputs the received crime statistics information on a user interface.
